(19) United States
(12) Patent Application Publication
(10) Pub. No.: US 2014/0085568 A1
(43) Pub. Date: Mar. 27, 2014

(54) Display Device

(71) Applicant: BOE Technology Group Co., Ltd., Beijing (CN)

(72) Inventors: Wenbo Li, Beijing (CN); Qingjiang Wang, Beijing (CN); Gang Wang, Beijing (CN)

(73) Assignee: BOE Technology Group Co., Ltd., Beijing (CN)

(21) Appl. No.: 14/016,723

(22) Filed: Sep. 3, 2013

(30) Foreign Application Priority Data
Sep. 21, 2012 (CN) 201210356972.5

(51) Int. Cl. G02F 1/1335; G02F 1/1334

(52) U.S. Cl. CPC G02F 1/133615; G02F 1/1334
USPC 349/62; 349/86; 349/74

(57) ABSTRACT

A display device is provided, comprising a display panel and a polymer dispersed liquid crystal panel overlapped in order, and an ambient light source system disposed at a side of the polymer dispersed liquid crystal panel opposite to the display panel. The display device is simplified in structure and driving circuit thereof while avoiding impact on heat-resistance performance of the PDLC panel resulted from over temperature of the light source at side of the light guide plate.

### BACKGROUND

Embodiments of the disclosed technology relates to a display device.

As illustrated in FIGS. 1A and 1B, the conventional display device includes a display panel 11, a light guide plate (LGP) 12, a polymer dispersed liquid crystal (PDLC) panel and a goods demonstration region 15 disposed in parallel in that order, and a backlight source 16 disposed at a side of the light guide plate 12. The PDLC panel includes a polymer dispersed liquid crystal 13 and transparent electrodes 14 provided on top and bottom surfaces thereof. In FIG. 1B, reference number 17 denotes an ambient light source.

In the conventional display device, the PDLC panel is placed between the light guide plate 12 and the goods demonstration region 15. When the PDLC is in an off state, the PDLC panel is in a scattering state, thereby allowing watching only displayed content on the display panel 11. When the PDLC is in an On state, the PDLC panel is in a transparent state, thereby allowing watching not only the displayed content on the display panel 11 but also goods exhibited behind the PDLC panel. A switch between the transparent display mode and the non-transparent display mode may be achieved by adjusting the PDLC panel.

However, there are shortages in the conventional display device design: the backlight at sides of the LGP will cause serious heat accumulation after continuous operation, which directly impacts normal operation of the PDLC panel, and even damages it.

### SUMMARY

One object of the present invention is to provide a display device, which is simplified in structure while allowing switching between a transparent display mode and a non-transparent display mode, and which can avoid impact on the heat-resistance performance of the PDLC panel due to over temperature resulted from the backlight source.

One embodiment of the present invention provides display device, comprising a display panel and a polymer dispersed liquid crystal panel overlapped in order, and an ambient light source system disposed at a side of the polymer dispersed liquid crystal panel opposite to the display panel.

In one example, the display panel is a liquid crystal display panel.

In one example, the display panel comprises a drive circuit of the display panel and a drive circuit of the polymer dispersed liquid crystal panel, wherein the drive circuit of the polymer dispersed liquid crystal panel is configured to control the On/Off state of the polymer dispersed liquid crystal panel.

In one example, the display panel and the polymer dispersed liquid crystal panel are disposed in parallel.

In one example, the light emitted by the ambient light source system is incident to the display panel via the polymer dispersed liquid crystal panel.

In one example, the ambient light source system is located in a plane perpendicular to the display panel and connected to an edge of the display panel.

In one example, the display device further comprises a remote control device, which supplies a signal for controlling the On/Off state of the polymer dispersed liquid crystal panel to the drive circuit of the polymer dispersed liquid crystal panel.

In one example, the remote control device comprises an infrared emitting diode, an infrared receiving diode and an infrared remote control circuit, the infrared remote control circuit being configured to control the On/Off state of the polymer dispersed liquid crystal panel by controlling the infrared emitting diode and the infrared receiving diode.

In one example, the infrared emitting diode and the infrared receiving diode are configured to be opposed to each other in a straight line.

In one example, the display device further comprises a housing in form of parallelepiped, which includes a front face and a rear face opposed to the front face, and four side faces connected to the front face and the rear face; wherein the display panel is located in the front face of the housing and is capable of being seen from outside of the housing, the display panel and the polymer dispersed liquid crystal panel being configured in parallel in that order from front to rear.

In one example, the ambient light source system is disposed on at least one of four inner wall surfaces of the four side faces and the inner wall surface of the rear face of the housing.

In one example, the housing is provided with a reflective plate attached to the respective inner wall surfaces.

In one example, the drive circuit of the polymer dispersed liquid crystal panel, the infrared remote control circuit and the drive circuit of the display panel are arranged integrally.

In one example, the housing includes an accommodation space therein between the polymer dispersed liquid crystal panel and the rear face of the housing.

The display device according to the embodiments of the present invention may be switched between the transparent display mode and non-transparent display mode while being simplified in structure and avoiding impact on the heat-resistance of the PDLC panel resulted from over temperature of the backlight source of a panel disposed at the side of the light guide plate, due to removal of a light guide plate configured between the display panel and the PDLC panel and a backlight source of a panel disposed side of the light guide plate.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1A is a schematic cross-section view of a conventional display device as PDLC being in an Off state;

FIG. 1B is a schematic cross-section view of a conventional display device as PDLC being in an On state;

FIG. 2A is a schematic cross-section view of a display device according to a first embodiment of the present invention as PDLC being in an Off state;

FIG. 2B is a schematic cross-section view of a display device according to a first embodiment of the present invention as PDLC being in an On state;

FIG. 3 is a schematic view of action between an infrared-emitting diode 221 and an infrared receiving diode 222 included by a display device drive circuit according to a third embodiment of the present invention;

FIG. 4 is a schematic view illustrating the relationship between circuits and the relating components

FIG. 5 is a structure view of display device according to a fourth embodiment of the present invention;

FIG. 6 is a schematic cross-section view of the display device according to a fourth embodiment of the present invention.

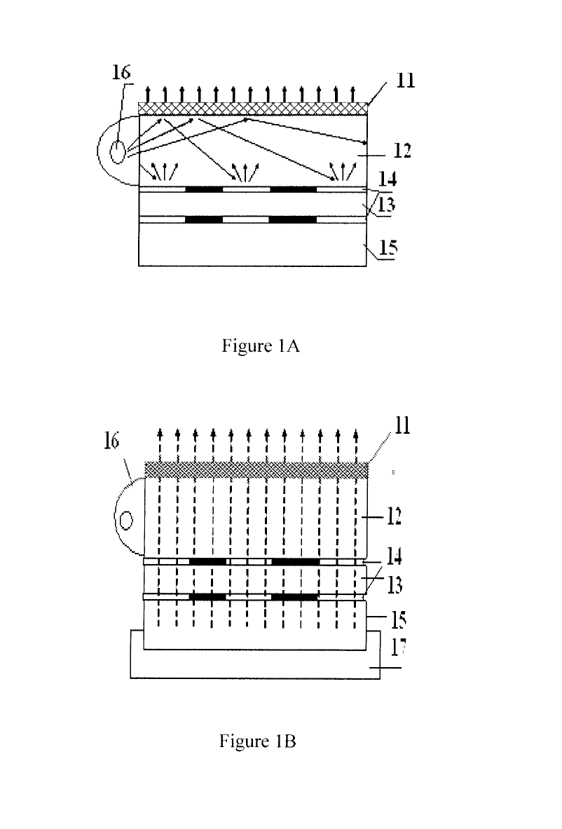

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

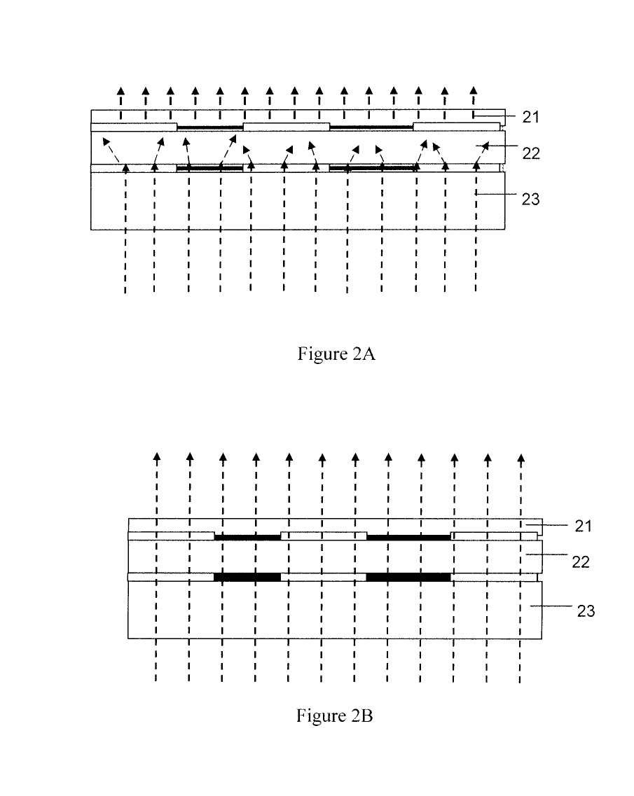

As illustrated in FIGS. 2A and 2B, a display device according to a first embodiment of the invention is provided, comprising a display panel 21, a drive circuit (not shown) of the display panel, a PDLC panel 22 and a drive circuit (not shown) of the PDLC panel.

The display panel 21 and the PDLC panel 22 are arranged in parallel.

The drive circuit of the PDLC panel is configured to control switching of the PDLC panel 22.

The display device according to an embodiment of the invention further comprises an ambient light source system for providing ambient light and acting as a backlight source of the display panel.

For example, the display panel 21 and the PDLC panel 22 are overlapped in order and the ambient light source system is disposed at the side of PDLC panel 22 opposite to the display panel 21. By this way, light from ambient light source is incident on the display panel 21 via the PDLC panel 22 as a backlight source of the display panel 21.

Reference number 23 indicates the goods demonstration region; the dash lines in FIG. 2A and 2B are represented to ambient light. When the PDLC panel 22 is in an off state, as shown in FIG. 2A, the light emitted from the ambient light source system is scatted by PDLC panel 22. Therefore, the goods demonstration region cannot be seen from the side of the display panel 21. When the PDLC panel 22 is in an On state, as shown in FIG. 2B, the light emitted from the ambient light source system is not scatted by PDLC panel 22. Therefore, at least the goods demonstration region can be seen from the side of the display panel 21.

As illustrated in FIGS. 2A and 2B, when the ambient light source system is concurrently used as the backlight of the display panel, the light emitted from it is incident to the display panel via the PDLC panel, as a backlight source of the display panel 21.

The display device according to the first embodiment of the present invention may be configured to switch between transparent display mode and non-transparent display mode. Further, due to removal of a light guide plate disposed between the display panel 21 and the PDLC panel 22 and a backlight of the panel disposed at the side of the light guide plate, the display device is simplified in structure and driving circuit thereof while avoiding impact on heat-resistance performance of the PDLC panel resulted from over temperature of the light source at the side of the light guide plate.

Meanwhile, light from ambient light system of the display device according to the embodiment of the present invention is incident to the display panel 21 via the PDLC panel 22, as a backlight of the display panel, ensuring normal operation of the display panel.

In the display device according to the second embodiment of the present invention, in practice, the light source system should be avoided to be located in the region adjacent to the display panel 21 and the PDLC panel 22, so as to avoid impact of over-temperature on the heat-resistance performance of the display panel 21 and the PDLC panel 22 due to the heat dispersion from the light source system.

In an example, the ambient light source system is located in a plane perpendicular to the display panel 21 and connected to the edge of the display panel 21, so as to improve utilization efficiency of the light source system.

The display device according to the third embodiment of the present invention is based on the display device of the first embodiment or the second embodiment of the present invention.

The display device according to the third embodiment of the present invention further includes a remote control device for controlling switching of the PDLC panel. That is, the remote control device is configured to provide signal to the driving circuit of the PDLC panel for controlling the switching of the PDLC panel.

The remote control device may be a remote control device based on Bluetooth communication, a remote control device based on infrared communication or a remote control device based on other types of short-range communication, which will not be listed in detail.

Further description is provided with the infrared remote control device as an example in detail.

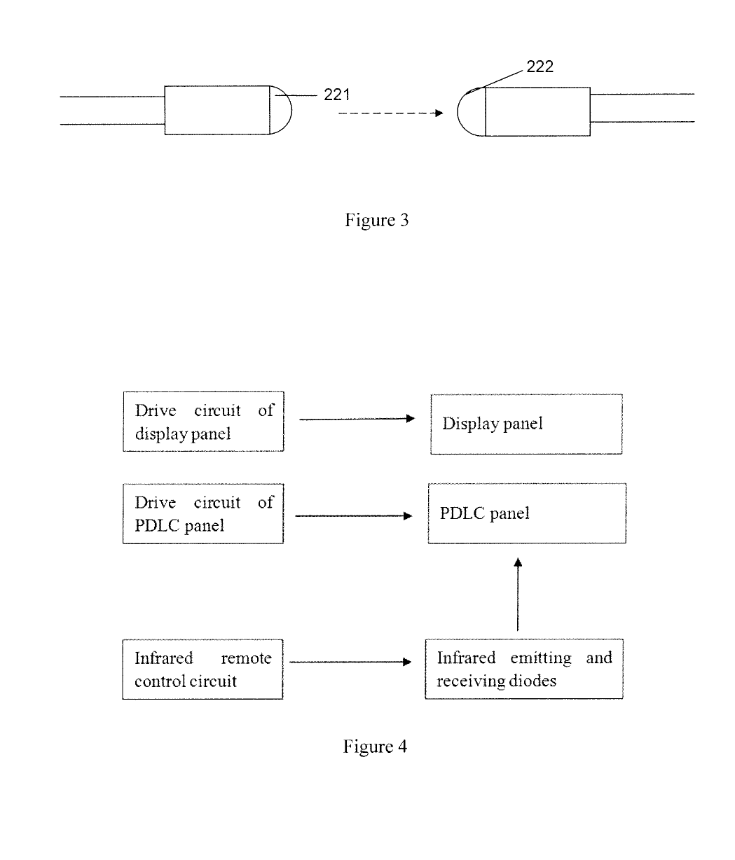

As shown in FIG. 3, in the third embodiment of the present invention, the remote control device includes an infrared emitting diode 221, an infrared receiving diode 222 and a infrared remote control circuit (not shown). The infrared remote control circuit controls the switching of the PDLC panel by controlling the infrared emitting diode and the infrared receiving diode.

The switching between the transparent display and non-transparent display modes of the display device according to the embodiment of the present invention is performed by the function of the PDLC panel 22 as a light valve. Thus, a remote switching between transparent display and non-transparent display modes may be performed only by infrared remotely controlling the PDLC panel 22.

In an example, the infrared emitting diode 221 and the infrared receiving diode 222 are configured to be opposed to each other in an approximate straight line, so as to ensure the infrared ray emitted from the infrared emitting diode 221 to be received by the infrared receiving diode 222, thereby resulting in an evident resistance change of the infrared receiving diode 222. The end-to-end distance between the infrared emitting diode 221 and the infrared receiving diode 222 may be up to several meters.

In an embodiment of the present invention, the drive circuit of the PDLC panel, the infrared remote control circuit and the drive circuit of the display panel may be configured individually, or integrally, such as, configured integrally in a chip or a circuit board.

As shown in FIG. 4, the relationships of the drive circuit or the control circuit and the relating components are illustrated. It can be seen from the figure that the drive circuit of the display panel is configured to control the operation of the display panel, the drive circuit of the polymer dispersed liquid crystal panel is configured to control the On/Off state of the polymer dispersed liquid crystal panel, and the infrared remote control circuit is configured to control the On/Off state of the polymer dispersed liquid crystal panel by controlling the infrared emitting diode and the infrared receiving diode.

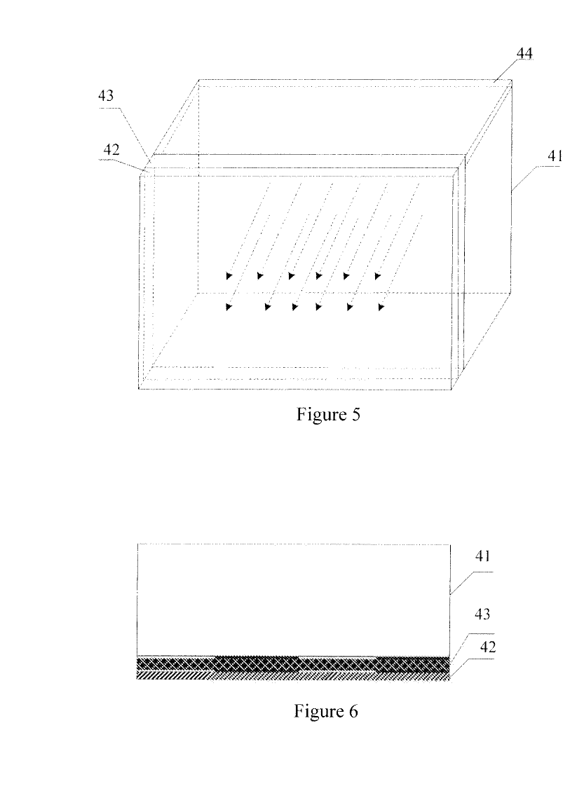

As illustrated in FIGS. 5 and 6, the display device according to the fourth embodiment includes a housing 41, a display panel 42, a PDLC panel 43 and a light source system 44. For example, the housing 41 is formed in shape of parallelepiped, and includes a front face and a rear face opposite to the front face, and four side faces connected to the front face and the rear face.

The display panel is located in front of the housing (here, a face which faces the user upon the display device working is defined the front face). The display panel and the PDLC panel are configured in parallel in that order from front to rear. For example, the display panel 21 may be viewed from outside of the housing.

The ambient light source system is disposed on an inner wall surface of the housing 41 for providing ambient light and simultaneously providing backlight for the display panel 42. The light from the ambient light source system is incident to the display panel 42 via the PDLC panel 43. In FIG. 5, the dash line is denoted the ambient light ray.

In practice, the ambient light source system may be configured on upper inner wall surface, right inner wall surface, left inner wall surface, rear inner wall surface and/or lower inner wall surface of the housing 41 (in FIG. 5, the ambient light source system 44 is disposed on the upper inner wall surface of the housing 41 as an example). As the ambient light source system is located on the upper inner wall surface, the right inner wall surface, the left inner wall surface and the rear inner wall surface of the housing 41, the problem of impact on viewing for excessive intensity of light can be avoided.

As an example, an accommodation space is provided between the PDLC panel and the rear face of the housing, which may be used for the goods demonstration region.

In an example, the housing 41 is provided with a reflective plate on each inner wall surface for increasing display brightness of the display panel 42 and providing a backlight source with increased intensity for the display panel 42.

In an embodiment, the ambient light source system may be a direct type light source system or an edge type light source system.

When it is a direct type light source system, the ambient light source system includes a light source and an optical film. The light source in this embodiment may a LED lamp, a CCFL lamp or the like. The light source are distributed evenly on the upper inner wall surface, the lower inner wall surface, the left inner wall surface, the right inner wall surface and/or the rear inner wall surface of the housing 41, and subsequently an optical film is arranged on the light source, so that light ray incident to the display panel becomes more uniform.

When it is an edge type light source system, the ambient light source system includes a light source, a light guide plate and an optical film. The light source in this embodiment may a LED lamp, a CCFL lamp or the like. The light source are arranged around edges (sides) of the upper inner wall surface, the lower inner wall surface, the left inner wall surface, the right inner wall surface and/or the rear inner wall surface of the housing 41, and subsequently the light guide plate is arranged at a side of the light source, so that the light emitted from the light source is guided and directed to the display panel upon being incident to the light guide plate. The light guide plate is provided with a plurality of optical films on the upper surface thereof, in which the plurality of optical films are configured to make the light incident to the display panel more even. The optical film may include a light diffusion film, a prism film, or the like.

The display panel 42 is configured on the front face of the housing 41, where the display panel 42 and the PDLC panel 43 are arranged in that order from front to rear in parallel. The goods demonstration region is located behind the PDLC panel within the housing 41.

In practice, the display device according to the fourth embodiment may be used to demonstrate sample. For example, in the case of demonstrating a sample, the PDLC panel 43 is controlled to be in transparent state and the demonstrated sample may be replaced according to the content displayed on the display panel 42. When no sample needs to be demonstrated, the PDLC panel 43 is controlled to be in the scattering state, so that only the content on the display panel 42 is displayed.

For example, in the display device according to the fourth embodiment of the present invention, the ambient light source system includes a LED lamp, a CCFL lamp or the like with a lead wire located adjacent to the right side of the housing 41, which facilitates connection to the circuit.

The ambient light source system includes an inverter drive circuit and the display panel includes a digital-to-analog conversion circuit. The inverter drive circuit, the digital-to-analog conversion circuit and the drive circuit of the PDLC panel may be arranged on any of inner wall surfaces of the housing 41. In an example, the inverter drive circuit of the ambient light source system, the digital-to-analog conversion circuit of the display panel 42 and the drive circuit of the PDLC panel are configured on the right side of the housing 41 and the lead wire of circuits is lead out on the right side of the housing, thereby being convenient for connection to the circuits.

The foregoing are merely exemplary embodiments of the invention, but are not used to limit the protection scope of the invention. The protection scope of the invention shall be defined by the attached claims.

What is claimed is:

1. A display device, comprising:
a display panel and a polymer dispersed liquid crystal panel overlapped in order, and
an ambient light source system disposed at a side of the polymer dispersed liquid crystal panel opposite to the display panel.

2. The display device according to claim 1, wherein the display panel is a liquid crystal display panel.

3. The display device according to claim 1, further comprising a drive circuit of the display panel and a drive circuit of the polymer dispersed liquid crystal panel, wherein the drive circuit of the polymer dispersed liquid crystal panel is configured to control the On/Off state of the polymer dispersed liquid crystal panel.

4. The display device according to claim 1, wherein the display panel and the polymer dispersed liquid crystal panel are disposed in parallel.

5. The display device according to claim 1, wherein the light emitted by the ambient light source system is incident to the display panel via the polymer dispersed liquid crystal panel.

6. The display device according to claim 1, wherein the ambient light source system is located in a plane perpendicular to the display panel and connected to an edge of the display panel.

7. The display device according to claim 3, further comprising a remote control device, which supplies a signal for controlling the On/Off state of the polymer dispersed liquid crystal panel to the drive circuit of the polymer dispersed liquid crystal panel.

8. The display device according to claim 7, wherein the remote control device comprises an infrared emitting diode, an infrared receiving diode and an infrared remote control circuit, the infrared remote control circuit being configured to control the On/Off state of the polymer dispersed liquid crystal panel by controlling the infrared emitting diode and the infrared receiving diode.

9. The display device according to claim 8, wherein the infrared emitting diode and the infrared receiving diode are configured to be opposed to each other in a straight line.

10. The display device according to claim 1, further comprising a housing in form of parallelepiped, which includes a front face and a rear face opposed to the front face, and four side faces connected to the front face and the rear face;
wherein the display panel is located in the front face of the housing and is capable of being seen from outside of the housing, the display panel and the polymer dispersed liquid crystal panel being configured in parallel in that order from front to rear.

11. The display device according to claim 10, wherein the ambient light source system is disposed on at least one of four inner wall surfaces of the four side faces and the inner wall surface of the rear face of the housing.

12. The display device according to claim 10, wherein the housing is provided with a reflective plate attached to the respective inner wall surfaces.

13. The display device according to claim 8, wherein the drive circuit of the polymer dispersed liquid crystal panel, the infrared remote control circuit and the drive circuit of the display panel are arranged integrally.

14. The display device according to claim 10, wherein the housing includes an accommodation space therein between the polymer dispersed liquid crystal panel and the rear face of the housing.
